(19) United States
(12) Patent Application Publication
(10) Pub. No.: US 2006/0184427 A1
(43) Pub. Date: Aug. 17, 2006

(54) System and method for providing exercise programs, goods and services

(76) Inventor: Jaswir Singh, Fresno, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/060,054

(22) Filed: Feb. 16, 2005

(51) Int. Cl. A63B 71/00; G06Q 30/00

(52) U.S. Cl. 705/26; 482/8

(57) ABSTRACT

A system and method for providing exercise programs, goods and services to users through a transmission system includes a database having a plurality of exercise video programs providing different types of exercise classes that can be accessed by registered users at a date, time and place that is convenient for the user to exercise. Preferably, the database is accessible via the Internet so the user can have access at the home, office, hotel rooms and many other Internet configured locations through an appropriately configured video device, such as a personal computer or television. The invention is configured to permit different levels of memberships so as to allow registered users access to different features of the exercise video program database. Preferably, the database includes special pay-per-view video programs, a marketplace section for purchasing goods and services, and a health/fitness section to provide health and fitness information.

### CROSS-REFERENCE TO RELATED APPLICATIONS

None.

### BACKGROUND OF THE INVENTION

A. Field of the Invention

The field of the present invention relates generally to systems and methods of providing information, goods and services to individuals desiring to improve their health and fitness. More particularly, this invention relates generally to such systems and methods that are directed to providing exercise information, goods and services over an online ordering. Even more particularly, the present invention relates to systems and methods of providing interactive exercise video programs, exercise related goods and health/fitness information to subscribers via the Internet or other transmission system.

B. Background

In today's society, most people know that watching their diet and following a fitness program can result in improved health, increased longevity, a more enjoyable life and other substantial benefits. As is also well known, many of these benefits are only achievable by engaging in sustained exercise, meaning exercise of sufficient intensity and durability to provide the desired benefits, on a regular basis. Despite the well known benefits of proper diet and exercise, information is widely available which indicates that a vast majority of people, particularly Americans, do not eat properly and do not get a sufficient amount of sustained exercise. As a result, many people are not considered to be physically fit or to be in good physical health. In fact, despite the many years and substantial effort by numerous government and private organizations to promote good health and exercise, many people are considered to be overweight or even obese. The health problems that are associated with the lack of exercise spans across all racial, gender and age boundaries. With regard to young people specifically, the lack of exercise and the problems resulting therefrom have been widely reported in government and private studies discussed by the media. Although many of the health problems associated with the lack of exercise may not become substantial or life threatening until a person is older, the importance of exercise for younger persons is well known. With regard to persons of any age, the lack of exercise hinders the person's ability to enjoy an active lifestyle. This is particularly true as people are living longer and having more years of life after retirement. With the additional time available to older persons after retirement, many of these people wish to engage in activities that are only doable or enjoyable, such as tennis, golf, hiking, long walking tours, swimming and the like, by being in good physical condition. Regular exercise is known to provide persons the ability to engage in numerous physical activities and have more fun while doing the activity.

In addition to improving the desire and ability to engage in physical activities, following recommended fitness and exercise guidelines, which have been established by various government agencies and private organizations, is also known to generally improve a person's health. The cost and availability of health care is a major issue in the United States. This is particularly true as the population of our country is generally becoming older. Although regular, sustained exercise is known to improve a person's health and reduce his or her likelihood of a number of health issues, including heart related diseases, most people have a difficult time obtaining sufficient exercise. As a result, in part, preventable health care costs have dramatically increased over the years. In response thereto, health care insurance premiums have substantially increased. For many individuals and companies, particularly small companies, health care and health insurance costs are a substantial financial burden. Naturally, for those persons who cannot afford or otherwise do not have health insurance, staying healthy is a financial necessity that must not be ignored.

Do in large part to the increased awareness of the health benefits of exercise and the desire for persons to be more physically fit, a number of health clubs and other exercise facilities have opened over the years to provide exercise equipment and classes to their patrons. Although many of these health club and health club related facilities are owned or operated by large companies, the market for such facilities is somewhat fragmented, with no one company controlling much of the market. Even in moderately sized cities, there are generally a multiple number of health clubs operated by a number of different owners. The cost and complexity of owning and operating health club facilities, from the initial investment in the buildings and exercise equipment to the ongoing costs of personnel, utilities and equipment upkeep or replacement, is known to be somewhat substantial. In order to keep existing customers and attract new customers, exercise and health clubs have found it desirable or necessary to offer more than just a place to use exercise equipment. Today, in addition to or even alternatively to weights and weight machines, most exercise and health clubs provide a variety of exercise classes and programs that are designed to appeal to persons interested in more than just the traditional methods of exercise. Although these classes were originally limited to standard aerobics exercises, most exercise classes today are directed to specialty types of exercise that may or may not involve the use of exercise equipment. For instance, classes are offered in such diverse activities as kick boxing, step aerobics, spinning using exercise bikes, yoga, pilates and a variety of others.

Although the various fitness classes and programs are very popular at most health clubs, they are known to have a number of limitations that prevent many people from fully benefitting from such classes and programs. One known limitation is that a person generally must join the health club in order to be able to participate in the exercise classes or programs. Even if the person is not at all interested in certain of the club's benefits, such as the exercise equipment, swimming pool, racquet courts and the like, his or her membership fees still reflect the initial investment, employee and upkeep costs associated with these benefits. Another known limitation is that the person can only participate in the class or program by being there at the date and time it is offered, whether that is a convenient date and time or not. For instance, a person who is a member at a particular health club may be interested in attending a certain class but, due to work or other conflicts, the schedule for the class is such that the person cannot participate. Even if the person's schedule is such that the class is generally available for them to attend, there is likely to be occasions when attending a particularly scheduled day or time will not be possible due to last minute conflicts. Another limitation is that the person must get to the health club, which under normal conditions typically requires driving to and from the health club and under bad weather conditions requires doing so in the fog, rain or snow. Yet another drawback, at least for some people, is the fact that the exercise classes are typically held as a group session and often in view of the other patrons of the health club. Although some people enjoy exercising in front of others, this is not the case for many, if not most, people who need to exercise. Whether because of embarrassment due to being so out of shape or due to general modesty and privacy concerns, some people are very reluctant to get into exercise clothes and exercise with a group of people, particularly if they feel the setting is such that they are on display (i.e., open areas or windows) while exercising.

The desire of persons to get into shape by exercising, particularly as part of a class-type of setting as opposed to running or the like, has resulted in a significant industry related to exercise video programs, whether offered on video tapes, DVDs or other formats. In fact, the amount of money spent on exercise video programs is substantial. Despite the popularity of such exercise video programs, particularly those having celebrity instructors, these programs are also known to have a number of limitations that prevent their full acceptance by many consumers. One of the major drawbacks to such exercise video programs is the cost associated with the purchase of a single program. The costs of the video tape, DVD or like is generally not insignificant, particularly when the consumer is not really sure if he or she will even like the program, the instructor or both. Often it may be hit or miss whether a particular consumer is going to enjoy interacting with a particular exercise program or the instructor leading/teaching the program. Even if the consumer does like the particular exercise program and instructor, there is a significant tendency for the consumer to become bored watching the same exercise video program over and over again. For those who master the exercise routine, this can be a particular problem that leads them to abandon the program and either cease exercising or have to purchase another exercise video program. Although some suppliers address this problem by providing graduated exercise or skill levels, taking advantage of these extra levels generally requires the consumer to purchase additional video programs from the supplier, resulting in an ever increasing investment in such programs.

What is needed, therefore, is an improved system and method of providing exercise programs, particularly exercise video programs, to consumers who wish to participate in such programs via the Internet, cable/satellite television or other transmission systems. The preferred system and method should allow a consumer to choose to participate in an exercise class or program at a day and time that is convenient to him or her by providing such classes and programs through an on-demand type of arrangement. The preferred system and method should also eliminate the cost associated with having to join an exercise or health club, with all of its weights, weight machines and other amenities, in order to be able to participate in an exercise class or program. The preferred system and method should also allow the consumer to choose the location, such as a home, office, hotel room or other location, that he or she will interact with exercise program so that he or she does not have to go to a facility and/or exercise in a group setting. The preferred system and method should provide various levels of memberships and allow the consumer to choose from a variety of different classes at different intensity and/or skill levels.

### SUMMARY OF THE INVENTION

The system and method for providing exercise programs, goods and services of the present invention provides the benefits and solves the problems identified above. That is to say, the present invention discloses a system and method that substantially improves the way in which people can interact with exercise classes or programs by allowing a person to choose the day and time when he or she desires to exercise. The present invention presents a business method that provides a database comprising a collection of numerous exercise video programs having different types of exercise classes, such as kick boxing, pilates, yoga, step aerobics and the like, taught by instructors in a class-type of setting that can be accessed by registered users at a day and time that is convenient for them to exercise. The database can be configured to include different exercise routines for the same type of exercise class and have different levels of exercise intensity to allow the user to progress to higher levels as he or she is able. Preferably, the database is accessible via the Internet so the user can have access at the home, office, hotel rooms and many other Internet configured places. Alternatively, the database can be configured to be accessible through a cable or satellite television system or a combination Internet/television system. The system and method of the present invention eliminates the need to join a health or exercise club for the person who merely wants to participate in exercise classes and allows persons to exercise in the comfort of their own home, office, room or other location. As such, the present invention is particularly friendly to and useable by those persons who do not desire to exercise in public and to those persons who, due to weather, car problems or other concerns, do not or cannot get to the health club. The preferred business method of the present invention is configured to allow different levels of memberships to allow registered users to access different features of the exercise video program database.

One aspect of the method of the present invention for providing exercise programs, goods and services over a transmission system, such as the Internet, generally comprises the steps of providing a user interface that is connected to and accessible through the transmission system, providing a database that is operatively connected to the user interface, allowing the user to selectively choose one of the video programs from the plurality of exercise video programs as his or her selected video, and delivering the selected video to the user via the transmission system. The database of the preferred embodiment of the present invention comprises a plurality of exercise video programs that are accessible to users, particularly registered users, through the user interface via the transmission system. In the preferred embodiment, the user accesses the database through a video device, such as a personal computer, digital video recorder or digital television, having a transmission system interface configured to access the transmission system and play the selected video on the video device so the user can exercise while watching the selected video. The user interface can be configured to determine if the user is a registered user, to register new users and to allow trial reviews for potential registered users. In the preferred embodiment, the database has a plurality of plan levels and the user is prompted to select one of the plurality of plan levels as his or her user plan when he or she becomes a registered user or to upgrade while a registered user. Each of the various plan levels include a selected subset or group of the complete database of exercise video programs. The user interface is configured to allow the user to access his or her user plan and choose a video from the group of exercise video programs in his or her user plan. Preferably, the database also includes a plurality of pay-per-view video programs, a marketplace section and a health fitness section. The user interface should be configured to allow the user to select one of the plurality of pay-per-view video programs as the selected video. The marketplace section should be configured to allow the user to purchase one or more goods and services through the transmission system.

One aspect of the system of the present invention for providing exercise programs, goods and services over a transmission system, such as the Internet, generally comprises a server computer having a user interface connected to and accessible through the transmission system, a database stored on the server computer and operatively connected to the user interface, a video device connected to the user interface through the transmission system, and a transmission system interface that connects the video device to the transmission system. As set forth above, the database has a plurality of exercise video programs that are accessible to the user via the transmission system and the video device is operated by the user so as to allow the user to selectively choose a selected video from the plurality of exercise video programs. The transmission system interface is configured to receive the selected video from the database via the transmission system and play the selected video on the video device to allow the user to interactively exercise while watching the selected video. For use with the Internet, the transmission system interface should comprise an appropriately configured Internet browser. The database used with the system has a plurality of plan levels each that each have a group of exercise video programs. The user interface is configured to allow the user to access his or her user plan and choose a video from the group of the exercise video programs in that plan. The database should include a plurality of pay-per-view video programs, a marketplace system and a health/fitness section. The user interface is configured to allow the user to select one of the plurality of pay-per-view video programs as the selected video and play that video on his or her video device.

Accordingly, the primary objective of the present invention is to provide an improved system and method for providing exercise programs, goods and services to consumers that provides the advantages described herein and that overcomes the disadvantages associated with presently available systems and methods of providing such exercise programs, particularly gym-based methods or video/DVD tapes.

It is also an important objective of the present invention to provide a system and method for providing exercise programs which comprises a database having plurality of exercise video programs that are accessible to users through an online, Internet-based server or by other transmission systems to allow the user to play a selected exercise video program so that he or she may interact therewith for exercise.

It is also an important objective of the present invention to provide a system and method for providing exercise programs through an Internet or other transmission system to a registered user that provides access to different types and levels of exercise video programs depending on the access plan selected by the user.

It is also an important objective of the present invention to provide a system and method for providing exercise programs that provides different levels of access to a database of exercise video programs, including unlimited, on-demand access to a plurality of exercise video programs within a group of programs for which the user is registered and options to allow the user to select other exercise video programs on a pay-to-watch type of arrangement.

It is also an important objective of the present invention to provide a system and method for providing exercise programs that allows the user to select when and where he or she desires to exercise in conjunction with an exercise class or program, thereby eliminating the user's dependency on health clubs and gyms for attending such classes or programs.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the best modes presently contemplated for carrying out the present invention:

FIG. 1 shows the general arrangement of a system configured to access and utilize the present invention, including a server configured to store a plurality of exercise videos and other information, the Internet and display devices and systems configured to receive and play a video selected from the server;

FIG. 2 is a logic flow diagram showing user access to a database system for playing exercise video programs in accordance with an embodiment of the present invention; and

FIG. 3 is a logic flow diagram illustrating the steps for handling a new user in accordance with an embodiment of the present invention.

### DETAILED DESCRIPTION OF THE PREFERRED EMBODIMENTS

With reference to the figures where like elements have been given like numerical designations to facilitate the reader's understanding of the present invention, and particularly with reference to the embodiments of the system and method for providing exercise programs, goods and services of the present invention illustrated in the figures, a preferred embodiment of the present invention is set forth below. The enclosed description and drawings are merely illustrative of one or more preferred embodiments and represent several different ways of configuring the present invention. Although specific components, materials, configurations and/or uses of the present invention are illustrated and set forth in the drawings and disclosure, those skilled in the art will readily understand that these embodiments are exemplifications of the principles of the present invention and that a number of variations can be made thereto without changing the scope and function of the invention set forth herein.

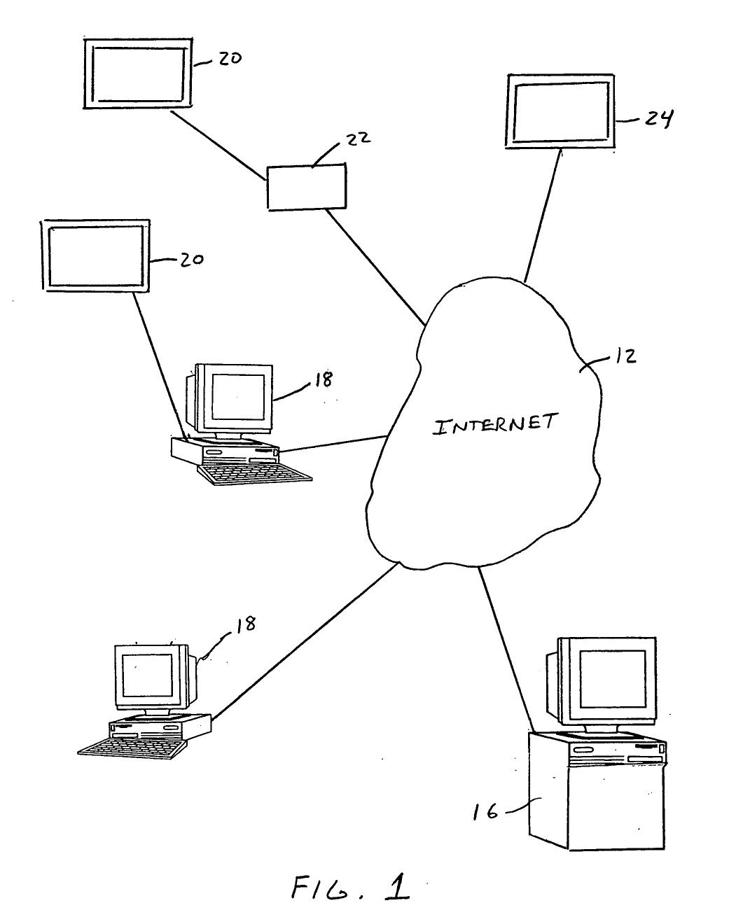

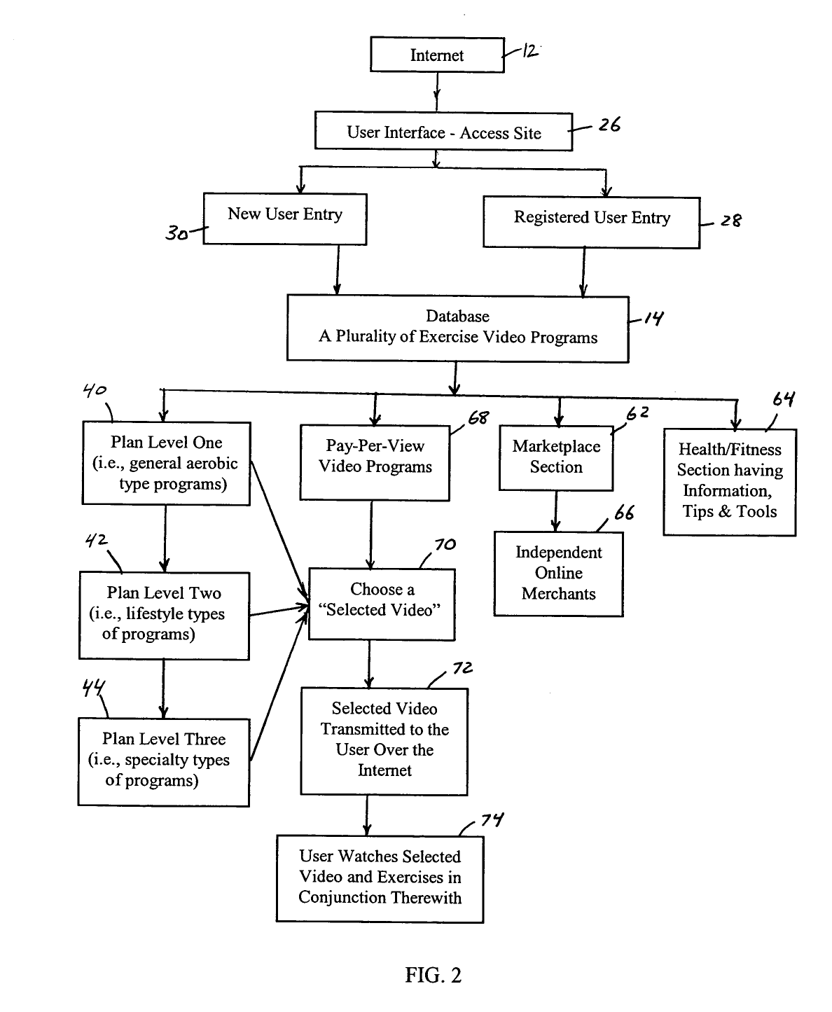

In reference to FIGS. 1 and 2, a preferred embodiment of the system and method for providing exercise programs, goods and services of the present invention, identified generally as 10, is configured for use with the Internet 12 so the user can readily access the database 14 having a plurality of previously recorded exercise video programs such, as those described below, from a variety of different locations. As is well known, many people have access to the Internet at their homes and offices. In addition, many hotels and motels offer Internet access in their rooms, often for a nominal fee. By providing access to the database 14 of the present invention 10 via the Internet 12, users will be able to benefit therefrom in the privacy of their homes, offices or hotel/motel rooms virtually anywhere in the world. As is well known with regard to Internet-based database systems in general, the system of the present invention 10 comprises a central server computer 16, or computer system comprising a plurality of such server computers 16, that have adequate memory and processing power to be suitable for storing the database 14 thereon and allowing access thereto from the Internet 12. Access to database 14 by the users can be by a variety of video devices, such as personal computer 18 shown in FIG. 1, that are also connected to the Internet 12. As illustrated in FIG. 1, depending on the user's set-up and equipment capabilities, computer 18 may interconnect a television 20 to the Internet 12, a digital recording device 22 (such as a TiVo® or similar device) may interconnect television 20 to the Internet 12 or a digital television 24 may be configured to connect directly to the Internet 12. As well known, connection to the Internet 12 may be achieved through cable modems, DSL systems, satellite, T-1 cable systems, wireless and dial up modems having 28 k, 56 k or higher connectivity capability.

For purposes of the disclosure herein, the system and method of the present invention 10 is generally described in conjunction with an Internet-based transmission system. However, as those skilled in the art will recognize, the invention is not so limited. The present invention 10 can be configured to be utilized with a variety of different video/data transmission systems which are capable of allowing the user to interact therewith. For instance, the system may be configured to be used with a cable television system, satellite systems or other present or future transmission systems that allow the user to interact therewith to select an exercise program, as explained in more detail below, for viewing on his or her video display device. User interactivity is presently well known in the art of providing video materials, as illustrated by the various pay-per-view types of services. It is contemplated that in the future there may be transmission systems which are an improvement over the presently available transmission systems, including the Internet 12. In any such transmission system, the goal is to allow the user to interact with database 14 configured according to the principles of the present invention 10 so that he or she may exercise therewith (as explained in more detail below).

As is well known in the art, video devices, such as personal computer 18, television 20, digital recorder 22 or digital television 24, must be configured to be able to display digital video images. For instance, in addition to sufficient connectivity capability, computer 18 must be configured with sufficient memory and processor speed to adequately process the digital video images associated with the exercise video programs of the present invention 10. In addition, the video device must have a transmission system interface having the capability to connect to the transmission system and a video display system, including a monitor and a high speed video card, capable of providing the desired video output quality. To connect to and interact with the Internet, personal computer 18, or other video devices, must be configured with an appropriate Internet browser, such as Microsoft's Explorer®) program. In addition, personal computer 18 will have to be provided with video display program, such as Real Player®), Windows Media Player® or Apple QuckTime®), suitable for playing the exercise video program. In general, the aforementioned programs, as well as others, are available for downloading from the Internet, or elsewhere, for a small or no fee (included with the computer, etc.). Once properly configured, the appropriate video device will be capable of receiving and playing an exercise video program selected by the user in accordance with the system and method 10 of the present invention.

A flow diagram illustrating the steps of a preferred embodiment of the system and method of the present invention 10 showing the interaction between the user and the database 14 is shown in FIG. 2. Initially, the system/method 10 is provided with a user interface 26 which is accessed via the Internet 12. As known to those skilled in the art, user interface 26 can welcome the user to the system/method 10 of the present invention, provide information regarding the services offered and request information from the user to proceed to access database 14, where a plurality of exercise video programs are stored. The first phase of the system/method 10 is to determine whether the user is a registered user or a new user. If the user is a previously registered user, then he or she will be directed to enter his or her user name and password, as shown at 28 on FIG. 2. Once the user name and password are entered and accepted, the user will be allowed access to database 14. If the user is not a registered user, he or she can be directed to become a new user, as shown at 30. As known in the art, the new user can be allowed access to database 14 in several different ways. For instance, new user could become a regular registered user whereby he or she pays a monthly or annual fee via credit card, bank withdrawal or mail-in payments. Alternative, new user could be provided with short-term access (i.e. a week or month, as may be appropriate or desired) to the system/method 10 of the present invention so that he or she could try it out before committing to a longer term contract. In another alternative, new user could be provided with a short term free access (i.e., three day pass) to database 14 to encourage him or her to become a registered user.

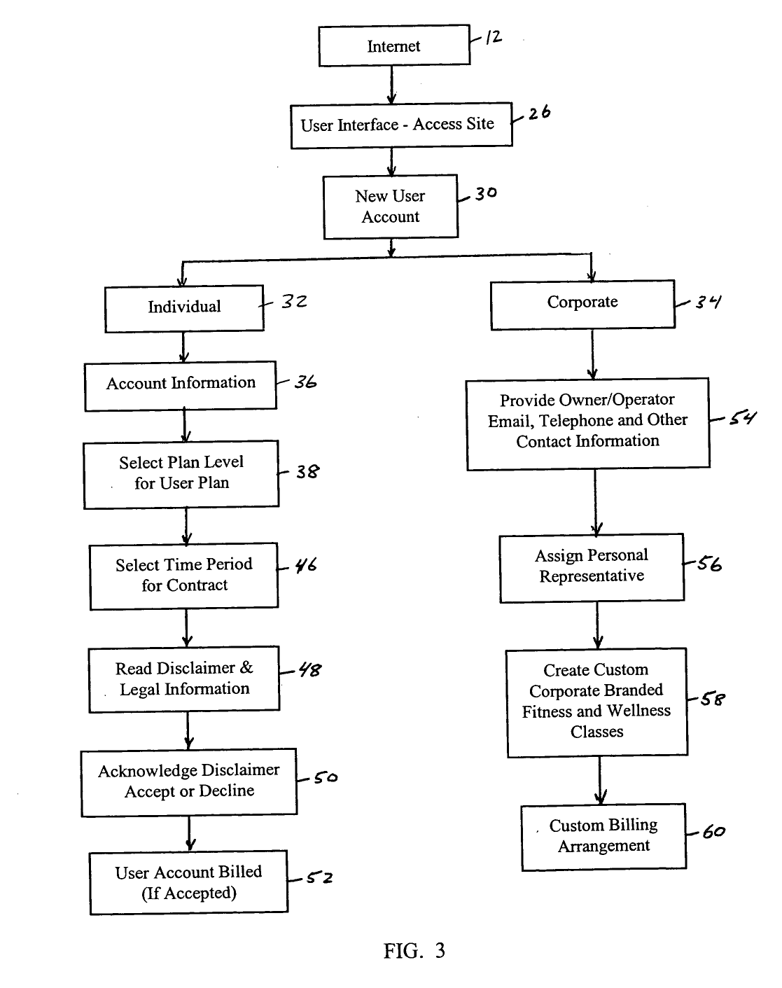

A flow diagram illustrating the steps of a preferred embodiment of the system/method 10 of the present invention for handling a new user is shown in FIG. 3. After accessing the site at user interface 26 through the Internet 12 and being directed to the new user account profile 30, the new user either selects the individual 32 or corporate 34 account status to enter the required information. If the new user is an individual, he or she will be directed to select a user name and password and then to enter the required account information, including name, address, telephone, email and payment information. After entering the necessary information, the new user is directed at 38 of FIG. 3 to select a plan level, such as Plan Level One 40, Plan Level Two 42 or Plan Level Three 44 (naturally, these plans may be referred to by other names, such as bronze, silver and gold) shown on FIG. 2. After selecting a plan, hereinafter referred to as the user plan, the new user is directed to 46 of FIG. 3 to select a time period, such as a trial period, one month, one year or multiple year periods for his or her commitment. As is known in the art, generally the new user can be provided with a discount for selecting longer periods of time. After selecting a time period the new user is directed to read the disclaimer and other legal information, shown at 48, that is required or recommended with regard to injuries, cancellations and other site specific information. The new user is then directed, at 50, to enter information whereby he or she acknowledges reading the disclaimer and legal information and then enters his or her desire to accept or decline the service. If the new user accepts the service, then the new user's account (such as a credit card or bank) is accessed at 52 and he or she becomes a registered user.

If the new user selects the corporate account status at 34, the user is provided information on opening a corporate or corporate-type account having multiple users who can access database 14 for the purposes described herein. At 54, the new user is given the email address, telephone number and other contact information to contact the owner of system/method 10 to facilitate the set-up of a corporate account. Alternatively, the corporate new user is prompted to provide his or her contact information so a representative of the owner can contact the corporate representative. In either instance, at 56 the owner of system/method 10 assigns a personal representative to the corporate account. At 58, the personal representative assists the corporate representative in creating custom corporate branded fitness and wellness classes that may be specifically targeted for the employees and other members of the corporate account. A custom billing arrangement for the corporate account is provided at 60. Once the corporate account is created, as well as any necessary sub-accounts, the employees and other members of that account can access the database 14 of the system/method 10 as registered users.

In reference to FIG. 2, after a user accesses database 14 of the system/method 10 of the present invention, he or she is directed either to select a exercise video program that he or she desires to interact with (as explained in more detail below) or to marketplace section 62 or health/fitness section 64 of the system/method 10. If the user chooses the marketplace section 62, he or she can be directed to purchase materials provided by the operators of the system/method 10 or, as shown at 66, to independent online merchants offering health and/or fitness related goods, such as clothing, sport drinks, nutrition bars, exercise equipment and the like, or a variety of health and/or fitness related services, such as sports medical services, diet programs, private training sessions and the like. The operators of system/method 10 can have financial arrangements with the independent online merchants such that the operators receive a percentage of all goods or services purchased by a registered user as a result of the referral by the system/method 10. At health/fitness section 64, the user can obtain information related to maintaining a healthy lifestyle, such as dietary, sleep and related data, or information related to improving his or her fitness, such as tips and tools on how to achieve the desired results faster, how to maintain the results achieved, methods of stretching, use of equipment and materials and the similar data. If desired, the operators of system/method 10 can allow non-registered users (i.e., guests) to have complete or partial access to the health/fitness section 64, bypassing the requirements of user interface 26, as a way to market the system/method 10 and/or as a public service.

In further reference to FIG. 2, once a user, typically a registered user, enters the database 14 of system/method 10, he or she can either choose to select one of the many available exercise video programs available under his or her user plan or select an exercise video program from the “pay-per-view” section, shown at 68, of the database 14. Once a exercise video program is selected, referred to as the “selected video” at 70, the selected video is electronically transmitted, shown at 72, to the user via the Internet 12 or other transmission system being utilized with the system/method 10 of the present invention. At 74, the user can then watch and interact with the selected video from 70 on his or her video device, such as personal computer 18, television 20 or digital television 24, while following along with the exercise class as if he or she is attending a class or program at a health club or exercise gym. Preferably, the selected video will be a live recording, previously recorded, of an actual exercise class that enables the user/viewer to follow along as if attending the class. Alternatively, the selected video can be a recording of an instructor who guides the user through the various steps of the exercise routine. In the preferred embodiment of the system/method 10 of the present invention, the user will have unlimited access to database 14 and usage of the plurality of exercise video programs contained therein and will be able to view and participate in any such programs within his or her user plan. As such, the user will be able to choose the day, time of day and the place that is most convenient for him or her, not for the instructor or health club/gym. This will greatly improve the user's ability to attend such classes and maintain his or her desired exercise program, even if the weather is bad or he or she is traveling away from home.

As set forth above, users can sign-up for one of a plurality of plans that are offered by the owner of system/method 10, such as the three plans shown in FIG. 2. In Plan Level One, shown as 40, the user can choose from a group of exercise video programs that are directed to basic or general aerobics type of workouts, including but not limited to yoga, pilates, biking, circuit training, aerobics, kick boxing, step aerobics, treadmill, stretching & flexibility, Tae-bo, hip-hop aerobics, cardio, weight loss, dance & fitness, hula, strength and weights. The above, which are set forth merely as examples, can be offered in various intensity levels, such as a beginner, intermediate and professional. In Plan Level Two, shown as 42, the user can choose from a group of programs including the exercise video programs in Plan Level One plus a variety of “lifestyle” type of classes, such as stress relief, parenting, seniors, kids only, new mothers, teens, abs, thighs & butts and cheer. As with the above, these are only set forth as examples and they may be offered in a variety of different intensity levels, such as beginner, intermediate and professional. In Plan Level Three, shown as 44, the user can choose from a group of programs including the exercise video programs in Plan Level Two (which includes Plan Level One) plus a variety of “speciality” workouts, such as kung fu, karate, judo, soccer, basketball, football, baseball, tennis, ice hockey, climbing and hiking. As with the above, these are only set forth as examples and they may be offered in a variety of different intensity levels, such as beginner, intermediate and professional. Those skilled in the art will understand that the above is merely exemplary of a format for the system/method 10 of the present invention. The various exercise video programs could all be offered under a single plan or under any number of plans in a variety of different combinations, which may or may not include access to the video programs of lower level plans. In addition, registered users can be provided with the option to upgrade or downgrade their memberships. The various plans can include standard subjects for the exercise video programs and include certain types of subjects that may be more of a local nature.

The system/method 10 of the present invention is adaptable to a variety of different modifications that allow the owner of system/method 10 to provide exercise video programs under varying circumstances to people having a wide range of interests. For instance, as set forth above, the system/method 10 can be configured to work with transmission systems other than the Internet 12. Some of these other transmission systems may be more suitable for areas of the country or world that are more remote, such as certain military or aid stations that may be located in areas that do not have reliable Internet access. In addition, it may be advantageous to combine the system/method 10 of the present invention with cable or satellite television broadcast capabilities so the user can watch the selected video directly on a suitably configured television. In addition, the various exercise video programs and other components of system/method 10 can be offered in different languages and/or adapted with printed words for the deaf. In an alternative embodiment of the present invention, the system/method 10 can be utilized by local health clubs and exercise gyms to routinely video tape all of their exercise classes so that if a person is unable to make a particular exercise class he or she can choose that class and participate in the class when he or she is able to, thereby avoiding having to miss a class and falling behind others in the class. Numerous other modifications and variations can also be made to the basic system/method 10 of the present invention.

In use, the user access the site at the user interface 26 and, if he or she is a registered user, enters his or her user name and password at 28. If a new user, the user enters at 30 and enters the appropriate information to either become a registered user or to obtain a short term pass to review the site. Once the user enters the database 14, comprising a plurality of exercise video programs and other information, he or she selects whether they want to enter their user plan, such as those shown on FIG. 2, utilize the pay-per-view feature at 68, enter the marketplace section 62 or access the health/fitness section 64. If the user desires to select an exercise video, he or she chooses a selected video from his or her user plan (such as the plans shown at 40, 42 and 44) or from the pay-per-view programs 68. Once a selected video is chosen, the user watches the video program on his or her video device and interacts therewith to accomplish the exercise routine. Because multiple classes of the same type and multiple levels of classes are offered, it is unlikely that the user will become bored or not be able to find a class that fits his or her needs and desires. The system/method 10 of the present can vastly improve the likelihood and ability of persons wanting to attend exercise classes by making such classes accessible to the person when and where it is convenient to him or her.

While the figures and description herein has set forth one or more preferred embodiments of the present invention, it will be readily apparent to those skilled in the art that the invention is not so limited, but is susceptible to various modifications and rearrangements without departing from the spirit and scope of the invention. For instance, many of the fundamental components used with the invention and described herein have equivalent functioning components that are well known with the art that can be used with the present invention. It is to be understood, therefore, that various modifications and rearrangements to the invention are contemplated herein. As such, the foregoing description is intended to be illustrative rather than limiting. The following claims, including all legal equivalents thereto, are intended to define the spirit and scope of the present invention.

What is claimed is:

1. A method of providing an exercise program to a user over a transmission system, said method including the steps of:
a) providing a user interface connected to and accessible through said transmission system;
b) providing a database operatively connected to said user interface, said database having a plurality of exercise video programs accessible to said user via said transmission system;
c) allowing said user to selectively choose a selected video from said plurality of exercise video programs; and
d) delivering said selected video to said user via said transmission system.

2. The method according to claim 1, wherein said transmission system is an Internet and said user interface is accessible and operable by a video device having a transmission system interface comprising an Internet browser.

3. The method according to claim 1, wherein said user interface is configured to determine if said user is a registered user.

4. The method according to claim 3, wherein said database is only accessible through said transmission system to said registered user.

5. The method according to claim 1, wherein said database has a plurality of plan levels and said user selects one of said plurality of plan levels as a user plan, each of said plan levels comprising a group of said exercise video programs, said user interface configured to allow said user to access said user plan and choose said selected video from said group of said exercise video programs in said user plan.

6. The method according to claim 1, wherein said database further comprises a plurality of pay-per-view video programs and said user interface is configured to allow said user to select one of said plurality of pay-per-view video programs as said selected video.

7. The method according to claim 1, wherein said database further comprises a marketplace section, said marketplace section configured to allow said user to purchase one or more goods and services through said transmission system.

8. The method according to claim 7, wherein said database further comprises a health/fitness section.

9. The method according to claim 1 further comprising the step of playing said selected video on a video device having a transmission system interface, said transmission system interface configured to receive and play said selected video so as to allow said user to interactively exercise while watching said selected video.

10. A method of providing an exercise program to a user over an Internet, said method including the steps of:
a) providing a user interface connected to and accessible through said Internet;
b) providing a database operatively connected to said user interface, said database having a plurality of exercise video programs accessible to said user via said Internet;
c) allowing said user to selectively choose a selected video from said plurality of exercise video programs;
d) delivering said selected video to said user via said Internet; and
e) playing said selected video on a video device having a transmission system interface, said transmission system interface comprising an Internet browser and configured to allow said user to interactively exercise during said playing of said selected video.

11. The method according to claim 10, wherein said user interface is configured to determine if said user is a registered user.

12. The method according to claim 10, wherein said database has a plurality of plan levels and said user selects one of said plurality of plan levels as a user plan, each of said plan levels comprising a group of said exercise video programs, said user interface configured to allow said user to access said user plan and choose said selected video from said group of said exercise video programs in said user plan.

13. The method according to claim 12, wherein said database further comprises a plurality of pay-per-view video programs and said user interface is configured to allow said user to select one of said plurality of pay-per-view video programs as said selected video.

14. The method according to claim 13, wherein said database further comprises a marketplace section, said marketplace section configured to allow said user to purchase one or more goods and services through said Internet.

15. The method according to claim 14, wherein said database further comprises a health/fitness section.

16. A system for providing an exercise program to a user over a transmission system, said system comprising:
a server computer having a user interface connected to and accessible through said transmission system;
a database stored on said server computer and operatively connected to said user interface, said database having a plurality of exercise video programs accessible to said user via said transmission system;
a video device connected to said user interface through said transmission system, said video device operated by said user so as to allow said user to selectively choose a selected video from said plurality of exercise video programs; and
a transmission system interface interconnecting said video device and said transmission system, said transmission system interface configured to receive said selected video from said database via said transmission system and play said selected video on said video device to allow said user to interactively exercise while watching said selected video.

17. The system according to claim 16, wherein said transmission system is an Internet and said transmission system interface comprises an Internet browser.

18. The method according to claim 16, wherein said user interface is configured to determine if said user is a registered user.

19. The system according to claim 16, wherein said database has a plurality of plan levels and said user selects one of said plurality of plan levels as a user plan, each of said plan levels comprising a group of said exercise video programs, said user interface configured to allow said user to access said user plan and choose said selected video from said group of said exercise video programs in said user plan.

20. The system according to claim 16, wherein said database further comprises a plurality of pay-per-view video programs and said user interface is configured to allow said user to select one of said plurality of pay-per-view video programs as said selected video.
